(19) United States
(12) Patent Application Publication
(10) Pub. No.: US 2026/0009967 A1
(43) Pub. Date: Jan. 8, 2026

(54) VIBRATING ACTUATOR, OPTICAL DEVICE, AND ELECTRONIC DEVICE

(71) Applicant: CANON KABUSHIKI KAISHA, Tokyo (JP)

(72) Inventors: YASUYUKI ARAKI, Tokyo (JP); KEI SUEFUJI, Tokyo (JP); SATOSHI TSUCHIYA, Saitama (JP)

(21) Appl. No.: 19/255,393

(22) Filed: Jun. 30, 2025

(30) Foreign Application Priority Data
Jul. 3, 2024 (JP) 2024-107525

(51) Int. Cl. G02B 7/08

(52) U.S. Cl. CPC G02B 7/08

(57) ABSTRACT

A vibrating actuator in which a vibration member including an electromechanical energy conversion element is vibrated to move the vibration member and a contact member in contact with the vibration member relative to each other in an x direction. The vibrating actuator includes a pressing member configured to press the vibration member and the contact member in a second direction intersecting with the first direction, a vibration attenuation member disposed in the second direction with respect to the contact member and configured to attenuate unnecessary vibrations occurring in the contact member, and a restraining member disposed on a side of the vibration attenuation member opposite to a side where the contact member is disposed and having higher rigidity than the vibration attenuation member.

### BACKGROUND

### Field of the Technology

The present disclosure relates to a vibrating actuator, an optical device, and an electronic device.

### Description of the Related Art

A vibrating actuator having the following configuration is known. That is, a vibration member, incorporating an electromechanical energy conversion element, and a contact member are pressurized to contact each other, and the vibration member is caused to excite predetermined vibration to supply a frictional driving force to the contact member from the vibration member, thus moving the vibration member and the contact member relative to each other. Japanese Patent Application Laid-Open No. 2023-108498 discusses a vibrating actuator having a configuration in which a vibration damping member (vibration attenuation member) including a viscoelastic member such as rubber is provided on a contact member so as to suppress unnecessary vibrations that cause an abnormal sound.

### SUMMARY

The present disclosure is directed to reducing variations in the performance of a vibrating actuator while ensuring sufficient vibration-damping properties.

According to an aspect of the present disclosure, a vibrating actuator includes a vibration member including an electromechanical energy conversion element, a contact member configured to be in contact with the vibration member, the vibrating actuator causing the vibration member to vibrate to move the vibration member and the contact member relative to each other in a first direction, a pressing member configured to press the vibration member and the contact member in a second direction intersecting with the first direction, a vibration attenuation member configured to attenuate unnecessary vibrations occurring in the contact member, the vibration attenuation member being disposed in the second direction with respect to the contact member, and a restraining member disposed on a side of the vibration attenuation member opposite to a side where the contact member is disposed, the restraining member having higher rigidity than the vibration attenuation member.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view illustrating a schematic configuration of a vibrating actuator according to a first exemplary embodiment, FIG. 1B is an exploded perspective view of the vibrating actuator illustrated in FIG. 1A, FIG. 1C is a sectional perspective view of the vibrating actuator illustrated in FIG. 1A, FIG. 1D illustrates the vibrating actuator illustrated in FIG. 1A as viewed from a positive Z-direction (+Z direction), FIG. 1E illustrates the vibrating actuator illustrated in FIG. 1A as viewed from a negative Z-direction (−Z direction), and FIG. 1F is a sectional view taken along a line B-B of the vibrating actuator illustrated in FIG. 1E.

FIG. 2A is an explanatory view illustrating a first vibration mode (hereinafter referred to as “mode A”) that is one of two bending vibration modes to be excited in a vibration member in the vibrating actuator according to the first exemplary embodiment, and FIG. 2B is an explanatory view illustrating a second vibration mode (hereinafter referred to as “mode B”) that is one of the two bending vibration modes to be excited in the vibration member in the vibrating actuator according to the first exemplary embodiment.

FIG. 3A illustrates a configuration example of each of the vibration member, a contact member, a vibration attenuation member, a restraining member, a fixed-side guiding member, and a rolling ball in the vibrating actuator according to the first exemplary embodiment, FIG. 3B illustrates a configuration example of each of the vibration member, the contact member, the vibration attenuation member, the restraining member, the fixed-side guiding member, and the rolling ball in the vibrating actuator according to the first exemplary embodiment, FIG. 3C illustrates a configuration example of each of the vibration member, the contact member, the vibration attenuation member, the restraining member, the fixed-side guiding member, and the rolling ball in the vibrating actuator according to the first exemplary embodiment, FIG. 3D illustrates a configuration example of each of the vibration member, the contact member, the vibration attenuation member, the restraining member, the fixed-side guiding member, and the rolling ball in the vibrating actuator according to the first exemplary embodiment, FIG. 3E illustrates a configuration example of each of the vibration member, the contact member, the vibration attenuation member, the restraining member, the fixed-side guiding member, and the rolling ball in the vibrating actuator according to the first exemplary embodiment, FIG. 3F illustrates a configuration example of each of the vibration member, the contact member, the vibration attenuation member, the restraining member, the fixed-side guiding member, and the rolling ball in the vibrating actuator according to the first exemplary embodiment, FIG. 3G illustrates a configuration example of each of the vibration member, the contact member, the vibration attenuation member, the restraining member, the fixed-side guiding member, and the rolling ball in the vibrating actuator according to the first exemplary embodiment, FIG. 3H illustrates a configuration example of each of the vibration member, the contact member, the vibration attenuation member, the restraining member, the fixed-side guiding member, and the rolling ball in the vibrating actuator according to the first exemplary embodiment, and FIG. 3I illustrates a configuration example of each of the vibration member, the contact member, the vibration attenuation member, the restraining member, the fixed-side guiding member, and the rolling ball in the vibrating actuator according to the first exemplary embodiment.

FIG. 4 is a graph illustrating an example of experimental results of vibration-damping properties in the vibrating actuator according to the first exemplary embodiment and vibrating actuators according to Comparative Examples.

FIG. 5 is a top view illustrating an example of a schematic configuration of an imaging device as an optical device according to a second exemplary embodiment.

FIG. 6 is a perspective view illustrating an example of a schematic configuration of an industrial robot as an electronic device according to the second exemplary embodiment.

### DESCRIPTION OF THE EMBODIMENTS

Exemplary embodiments of the present disclosure will be described below with reference to the accompanying drawings.

A first exemplary embodiment will now be described.

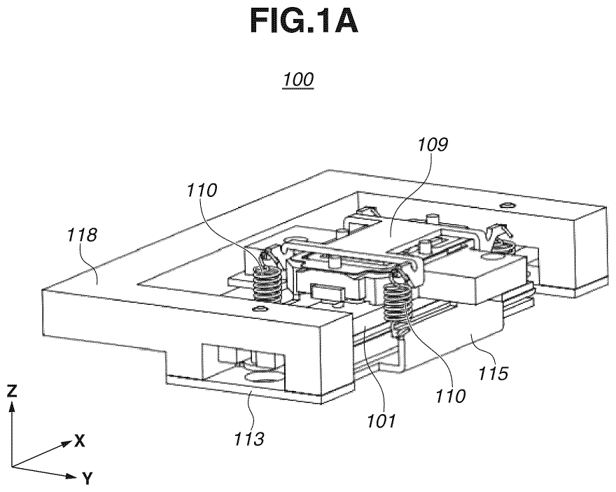

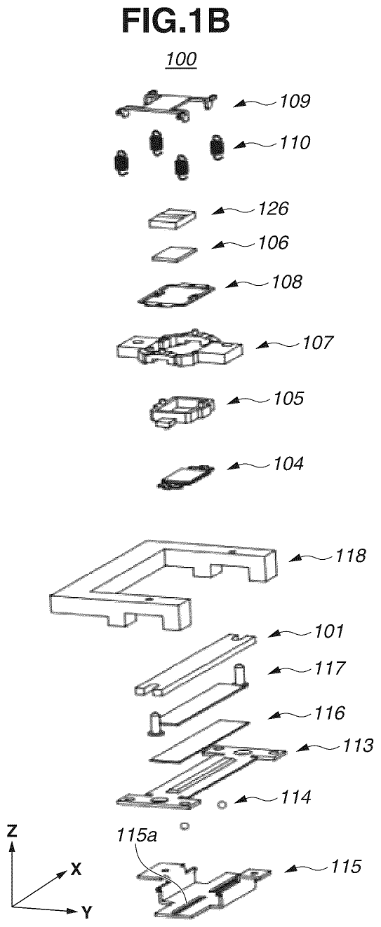

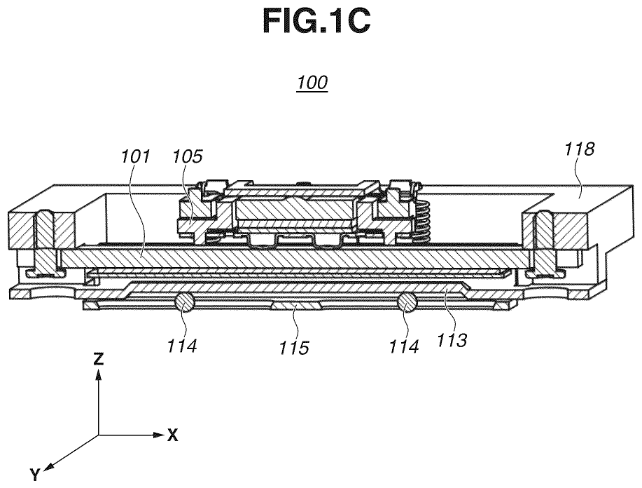

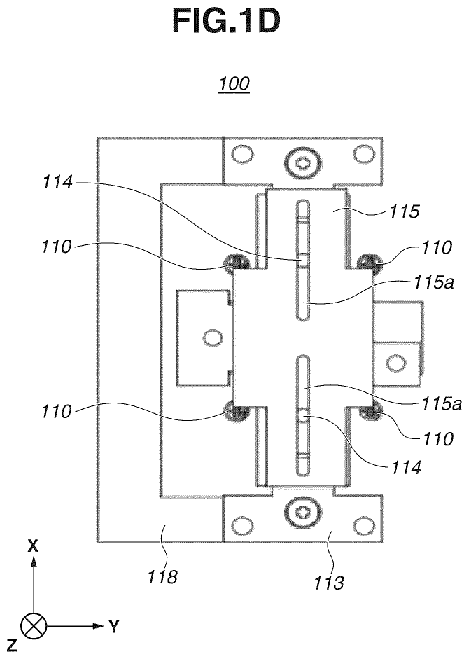

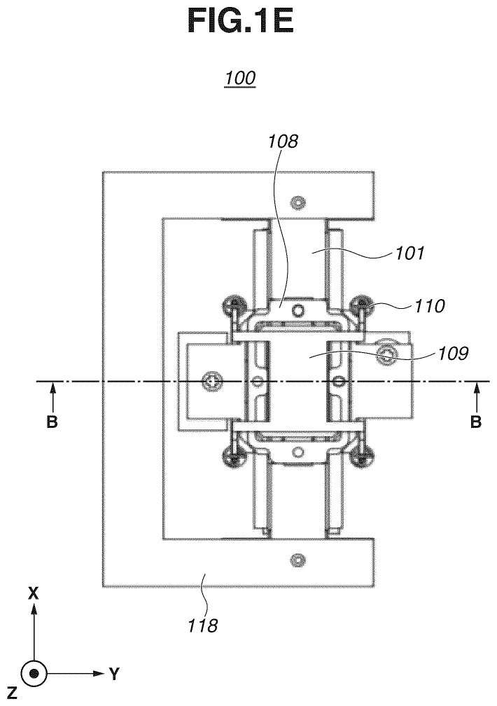

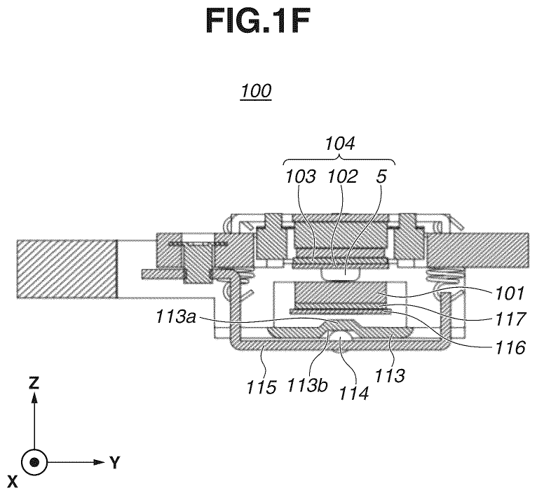

FIG. 1A is a perspective view illustrating a schematic configuration of a vibrating actuator 100 according to the first exemplary embodiment. In FIG. 1A, the vertical direction is defined as the Z direction, and the two directions, which define a horizontal plane orthogonal to the Z direction, are defined as the X direction and the Y direction, forming an XYZ coordinate system. FIG. 1B is an exploded perspective view of the vibrating actuator 100 illustrated in FIG. 1A. FIG. 1C is a sectional perspective view of the vibrating actuator 100 illustrated in FIG. 1A. FIG. 1D illustrates the vibrating actuator 100 illustrated in FIG. 1A as viewed from a positive Z-direction (+Z direction). FIG. 1E illustrates the vibrating actuator 100 illustrated in FIG. 1A as viewed from a negative Z-direction (−Z direction). FIG. 1F is a sectional view taken along a line B-B of the vibrating actuator 100 illustrated in FIG. 1E. In FIGS. 1A to IF, the same components are denoted by the same reference numerals. FIGS. 1B to IF each illustrate an XYZ coordinate system corresponding to the XYZ coordinate system illustrated in FIG. 1A.

As illustrated in FIGS. 1B and 1F, the vibrating actuator 100 includes a vibration member 104 and a contact member 101 configured to be in contact with the vibration member 104. In the first exemplary embodiment, the vibration member 104 has a rectangular shape. As illustrated in FIG. 1F, the vibration member 104 includes a flat-plate-like elastic member 102, a piezoelectric element 103 that is bonded to one surface of the elastic member 102 and serves as an electromechanical energy conversion element, and two protruding portions 5 on the other surface of the elastic member 102.

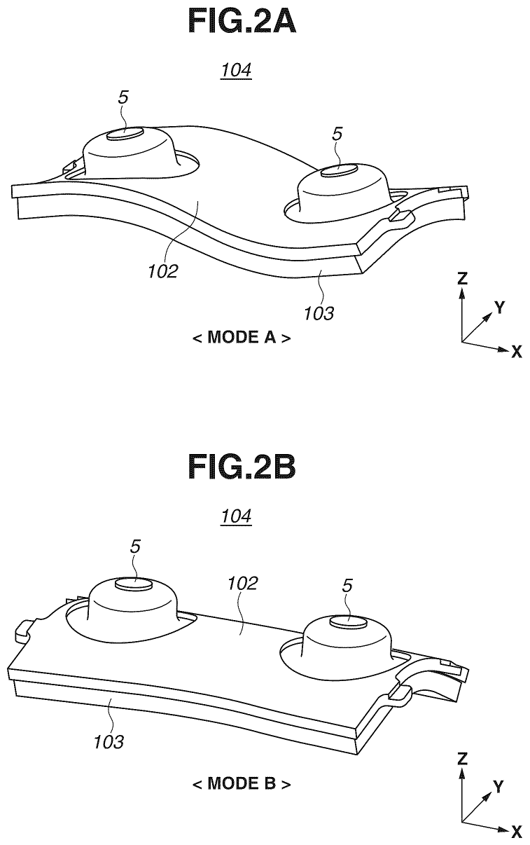

Two bending vibration modes for bending vibration to be excited in the vibration member 104 will be described with reference to FIGS. 2A and 2B.

FIG. 2A is an explanatory view illustrating a first vibration mode (hereinafter referred to as “mode A”) that is one of the two modes for bending vibrations to be excited in the vibration member 104 in the vibrating actuator 100 according to the first exemplary embodiment. In FIG. 2A, components similar to the components illustrated in FIG. 1F are denoted by the same reference numerals, and detailed descriptions thereof are omitted. FIG. 2A illustrates an XYZ coordinate system corresponding to the XYZ coordinate system illustrated in FIGS. 1A to IF. In the vibration member 104, a common electrode (full-surface electrode, not illustrated) is disposed on a side surface of the elastic member 102 in the piezoelectric element 103, and a driving electrode separated into two equal parts in a length direction is disposed on the surface of the piezoelectric element 103 opposite to the surface joined to the elastic member 102. The mode A illustrated in FIG. 2A is a secondary bending vibration in a longitudinal direction (X-direction) of the vibration member 104 and has three node lines substantially parallel to a widthwise direction (Y-direction, i.e., width direction) of the vibration member 104. Application of an alternating voltage with a phase shift of 180° at a predetermined frequency to the driving electrode of the piezoelectric element 103 makes it possible to excite the vibration of the mode A in the vibration member 104. The protruding portions 5 are disposed in the vicinity of positions corresponding to nodes of the vibration of the mode A, and the protruding portions 5 are each caused to perform reciprocating motion in the X-direction by the vibration of the mode A being excited in the vibration member 104.

FIG. 2B is an explanatory view illustrating a second vibration mode (hereinafter referred to as “mode B”) that is one of the two modes for bending vibrations to be excited in the vibration member 104 in the vibrating actuator 100 according to the first exemplary embodiment. FIG. 2B illustrates an XYZ coordinate system corresponding to the XYZ coordinate system illustrated in FIGS. 1A to IF. The mode B is a primary bending vibration in the widthwise direction (Y-direction) of the vibration member 104 and has two node lines substantially parallel to the longitudinal direction (X-direction) of the vibration member 104. Application of an alternating voltage with the same phase at a predetermined frequency to the driving electrodes of the piezoelectric element 103 makes it possible to excite the vibration of the mode B in the vibration member 104. The protruding portions 5 are disposed in the vicinity of positions corresponding to antinodes of the vibration of the mode B, and the protruding portions 5 are each caused to perform reciprocating motion in an axial direction (Z-direction) of the corresponding protruding portion 5 by the vibration of the mode B being excited in the vibration member 104.

The vibration member 104 is configured such that the node lines in the mode A are substantially perpendicular to the node lines in the mode B within an X-Y plane. The piezoelectric element 103 is bonded to a flexible substrate (not illustrated), and an alternating current is supplied to the piezoelectric element 103 through this flexible substrate, thus simultaneously exciting the vibration of the mode A and the vibration of the mode B in the vibration member 104. Thus, the vibration of the mode A and the vibration of the mode B are excited with a predetermined phase difference, thereby generating an elliptical motion within a Z-X plane at the tip ends of the protruding portions 5.

In the vibrating actuator 100, the vibration member 104 is in contact with the contact member 101. Thus, a substantially elliptical motion at the tip ends of the two protruding portions 5 induced by the simultaneous excitation of the vibration of the mode

A and the vibration of the mode B moves the vibration member 104 relative to the contact member 101. In the first exemplary embodiment, a direction in which the vibration member 104 and the contact member 101 are allowed to move relative to each other when the vibration member 104 is caused to vibrate (first direction, e.g., the X-direction in the present exemplary embodiment) is referred to as a driving direction.

Referring again to FIGS. 1A to IF, the description is continued.

As illustrated in FIGS. 1A and 1B, springs 110 (pressing members) that are tension springs are arranged at four locations around the vibration member 104 and generate a pressurizing force for pressing the vibration member 104 and the contact member 101 against each other to be pressurized to contact each other. It is not necessary to use the four springs 110 to apply the pressurizing force. The springs 110 are not limited only to tension springs, but any type of springs can be used as the springs 110. In the present exemplary embodiment, the direction of the pressurizing force for pressurizing the vibration member 104 and the contact member 101 against each other to contact each other is referred to as a pressurizing direction, and the pressurizing direction corresponds to the Z-direction in FIGS. 1A to IF.

As illustrated in FIGS. 1A and 1B, one end of each of the four springs 110 is supported by a pressurizing plate 109, and the other end of the corresponding four springs 110 is supported by a movable-side guiding member 115. The four springs 110 generate a pressurizing force for pressuring the vibration member 104 and the contact member 101 against each other to contact each other.

The pressurizing plate 109 is in contact with an elastic member bonding member 126 illustrated in FIG. 1B and transmits the pressurizing force generated by the springs 110 to the elastic member bonding member 126. An elastic member 106 is disposed between the elastic member bonding member 126 and the vibration member 104 (piezoelectric element 103).

The elastic member bonding member 126 and the elastic member 106 are used for preventing the pressurizing plate 109 and the vibration member 104 (piezoelectric element 103) from being brought into direct contact with each other, thereby preventing damage to the vibration member 104 (piezoelectric element 103). One or both of the elastic member bonding member 126 and the elastic member 106 may be omitted.

As illustrated in FIG. 1B, the movable-side guiding member 115 includes two movable-side rolling grooves 115a that are grooves having a substantially V-shape. Rolling balls 114 are located in the respective movable-side rolling grooves 115a. The movable-side guiding member 115 includes hook portions to fix the springs 110. As illustrated in FIG. 1F, a fixed-side guiding member 113 includes fixed-side rolling groove 113a that are grooves having a substantially trapezoidal shape. The rolling balls 114 are held between the fixed-side rolling groove 113a of the fixed-side guiding member 113 and the movable-side rolling grooves 115a of the movable-side guiding member 115. The springs 110 are used to hold the rolling balls 114. A force for holding the rolling balls 114 by the springs 110 is equal to the pressurizing force for pressurizing the vibration member 104 and the contact member 101 against each other to contact each other.

A guiding mechanism configured with the fixed-side rolling groove 113a, the rolling balls 114, and the movable-side rolling grooves 115a moves the vibration member 104 relative to the contact member 101.

A vibration member holding member 105 illustrated in FIGS. 1B and 1C holds the vibration member 104 by holding an arm portion extending from a flat plate portion of the elastic member 102. In the case of holding the arm portion of the elastic member 102, the vibration member holding member 105 holds a node portion or a portion in the vicinity of the node portion of the vibration to be excited in the vibration member 104. The vibration member holding member 105 and the elastic member 102 are fixed with an adhesive or the like.

A movable frame member 107 illustrated in FIG. 1B is joined to the vibration member holding member 105 through a thin sheet metal 108. In such a case, the relative movement of the vibration member holding member 105 and the movable frame member 107 in the driving direction is restricted more than the relative movement in the direction of the pressurizing force. This configuration makes it possible to stably pressurize the vibration member 104 to contact the contact member 101 while reducing backlash of the vibration member holding member 105 and the movable frame member 107 in the driving direction. Any configuration that provides the same advantageous effects as those of the thin sheet metal 108 may be used to join the movable frame member 107 and the vibration member holding member 105.

Configuration examples of the contact member 101, a vibration attenuation member 117, a restraining member 116, the fixed-side guiding member 113, and a fixing frame member 118 illustrated in FIGS. 1A to IF will now be described.

As illustrated in FIG. 1C, the contact member 101 is fixed to the fixing frame member 118 with screws at both ends thereof in the driving direction. The fixing frame member 118 is a fixing member made of resin. As a resin material for forming the fixing frame member 118, at least one of a liquid crystal polymer (LCP) resin, an acrylonitrile butadiene styrene (ABS) resin, and a carbon fiber reinforced polycarbonate (PC) resin, each of which has vibration-damping properties, may be desirably used. The fixed-side guiding member 113 that is made of metal and guides the relative movement between the vibration member 104 and the contact member 101 is also fixed to the fixing frame member 118 with screws (not illustrated) at both ends thereof in the driving direction.

Specifically, in the first exemplary embodiment, the contact member 101, the vibration attenuation member 117, the restraining member 116, the fixed-side guiding member 113, and the fixing frame member 118 are integrally formed. In the example illustrated in FIG. 1C, the fixed-side guiding member 113 is joined to the contact member 101 through the fixing frame member 118 serving as a fixing member. The rolling balls 114 each serving as a rolling member roll on a surface (lower surface in FIG. 1C) of the fixed-side guiding member 113.

As illustrated in FIG. 1F, the fixed-side guiding member 113 has the fixed-side rolling groove 113a having a convex portion extending in the X-direction. The fixed-side rolling groove 113a having the convex portion is located at a position overlapping the corresponding protruding portion 5 of the vibration member 104 in the Z-direction. Each fixed-side rolling groove 113a having the convex portion is formed by, for example, press work. A concave portion 113b is formed on a side opposite to the side where the convex portion is disposed. The concave portion 113b forms a rolling groove in which the rolling ball 114 rolls.

The vibration attenuation member 117 illustrated in FIGS. 1B and 1F is disposed in the Z-direction that is a second direction intersecting with (to be more specific, perpendicular to) the above-described first direction with respect to the contact member 101. Specifically, as with the contact member 101, the vibration attenuation member 117 extends in the X-direction and is in contact with the contact member 101 on the opposite side of the vibration member 104. The vibration attenuation member 117 has a function of attenuating unnecessary vibrations occurring in the contact member 101. The surface of the vibration attenuation member 117 that is opposite to the surface in contact with the contact member 101 is in contact with the restraining member 116.

The width of the vibration attenuation member 117 may be desirably equal to or greater than the width of the contact member 101 in terms of vibration-damping properties. The term “width” of each member refers to the length of each member in the Y-direction (direction perpendicular to the above-described first direction).

It may be desirable to use rubber or resin having high vibration-damping properties (e.g., having a high vibration-damping ratio) as a material for the vibration attenuation member 117. In a case where the vibration attenuation member 117 is formed of rubber, for example, butyl rubber, butadiene rubber, or silicone rubber may be preferably used. In the case of using butyl rubber as a material for the vibration attenuation member 117, butyl rubber may desirably have high hardness of, for example, 50° or 70°. Shear deformation of the vibration attenuation member 117 due to bending vibration converts vibration energy of unnecessary vibrations in an out-of-plane direction occurring in the contact member 101 into thermal energy, thereby making it possible to attenuate unnecessary vibrations occurring in the contact member 101.

As an additional effect, the vibration attenuation member 117 has elasticity but is not held between the contact member 101 and the fixed-side guiding member 113, thus avoiding being crushed. Thus, an elastic reaction force does not occur on the contact member 101 and the fixed-side guiding member 113. This configuration prevents the contact member 101, the fixing frame member 118 joined to the contact member 101, and the other members from being deformed due to the vibration attenuation member 117.

If the vibration attenuation member 117 is thick enough to be held between the contact member 101 and the fixed-side guiding member 113 to be crushed, the contact member 101 receives the reaction force, causing a center portion of the contact member 101 is bent relative to both ends thereof. As a result, when the vibration member 104 is located at the center, the contact member 101 bends, causing the springs 110 used for applying pressure to extend by the amount of the bend, which increases the pressing force and consequently the power consumption. The configuration according to the first exemplary embodiment can avoid such an issue.

In the first exemplary embodiment, variations in the dimensions of the vibration attenuation member 117 depending on manufacturing lots are more likely to occur than in the other members that constitute the vibrating actuator 100. The dimensions of each of the fixed-side guiding member 113 and the restraining member 116 are set so as to prevent the fixed-side guiding member 113 and the restraining member 116 from interfering with each other even when the thickness of each member has reached an upper limit of tolerance. This configuration makes it possible to reduce variations in the driving performance of the vibrating actuator 100 without causing variations in pressurizing force due to variations in the thickness of the vibration attenuation member 117.

The restraining member 116 illustrated in FIGS. 1B and 1F is used for restraining deformation (shear deformation) of the vibration attenuation member 117. The restraining member 116 is a member that is disposed on the side of the vibration attenuation member 117 that is opposite to the side where the contact member 101 is disposed, and the restraining member 116 has higher rigidity than the vibration attenuation member 117. In the vibrating actuator 100 according to the present exemplary embodiment, the restraining member 116 is not in contact with the fixed-side rolling groove 113a having the convex portion of the fixed-side guiding member 113 as illustrated in FIG. 1F. This configuration of the vibrating actuator 100 prevents the vibration attenuation member 117 from substantially receiving a pressing force generated by the action of the springs 110 each serving as the pressing member to press the contact member 101 and the vibration member 104. In the present exemplary embodiment, a gap formed between the restraining member 116 and the fixed-side guiding member 113 in the Z-direction corresponding to the second direction described above prevents the vibration attenuation member 117 from receiving the pressing force generated by the action of the springs 110. In this case, the pressing force generated by the action of the springs 110 is a force acting in the Z-direction corresponding to the second direction described above. In the present exemplary embodiment, at least one of gas including air, cotton, felt, gel, grease, and a foaming member may be desirably present in the gap between the restraining member 116 and the fixed-side guiding member 113 in the Z-direction.

The number of each of the vibration attenuation member 117 and the restraining member 116 to be provided is not limited to one. For example, a plurality of vibration attenuation member 117 and a plurality of restraining member 116 may be alternately arranged to form a multi-layer structure. This multi-layer structure makes it possible to effectively reduce the vibration amplitude of unnecessary vibrations occurring in the contact member 101.

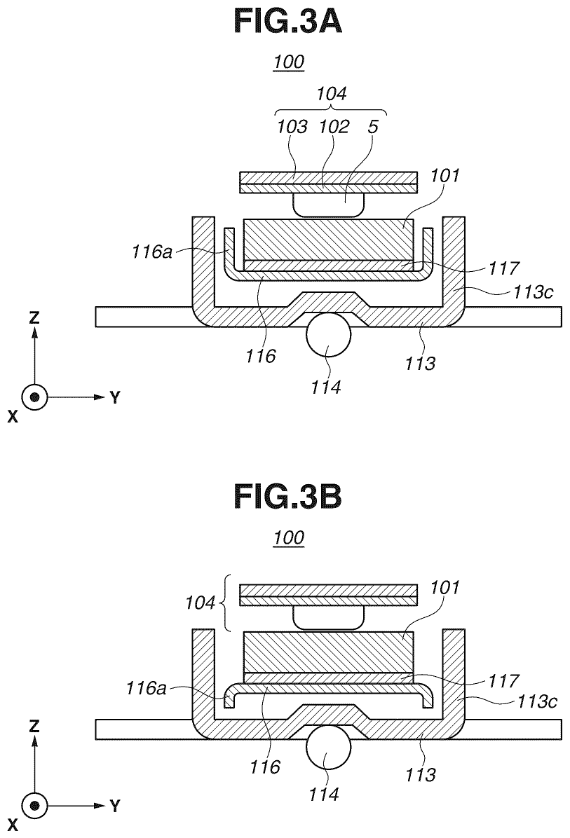

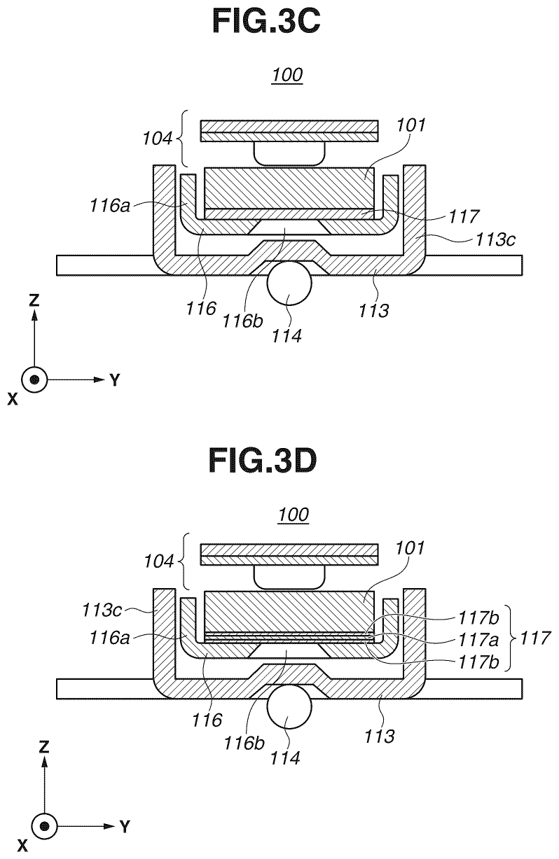

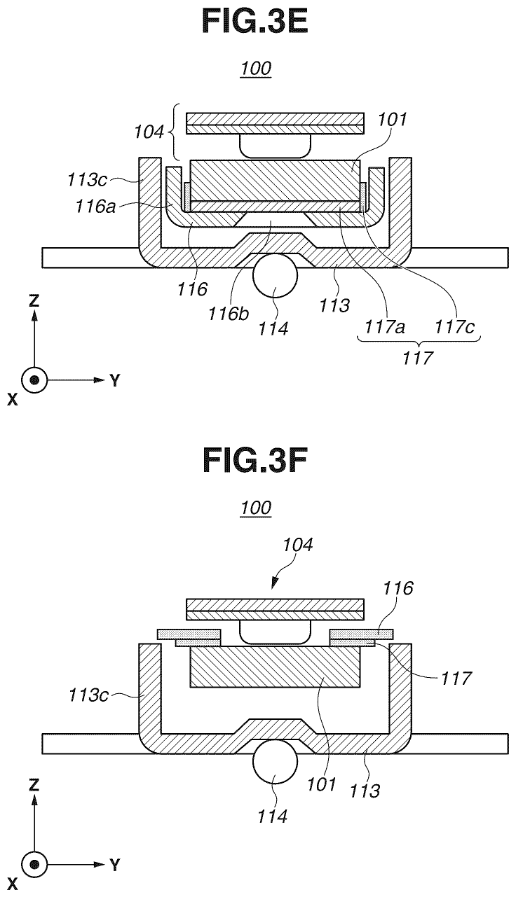

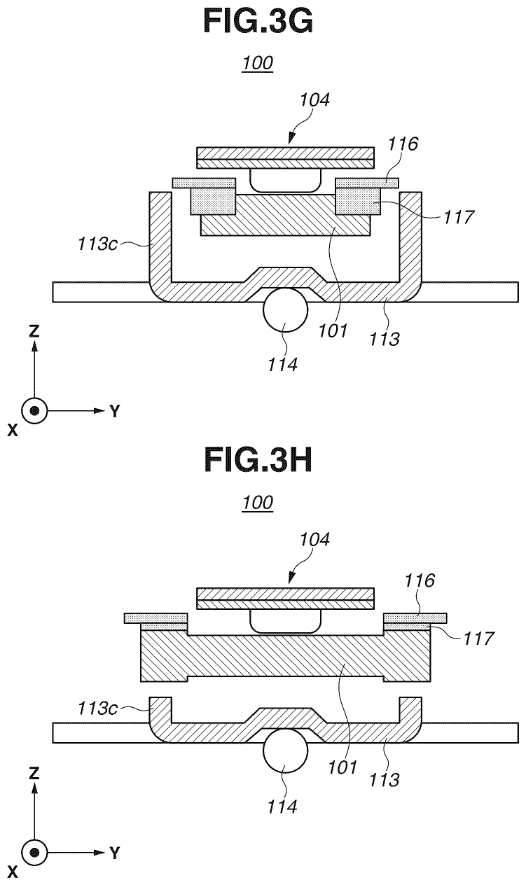

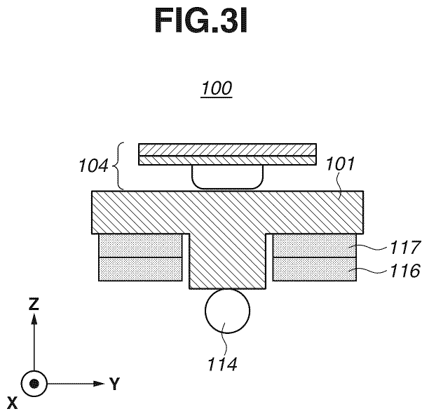

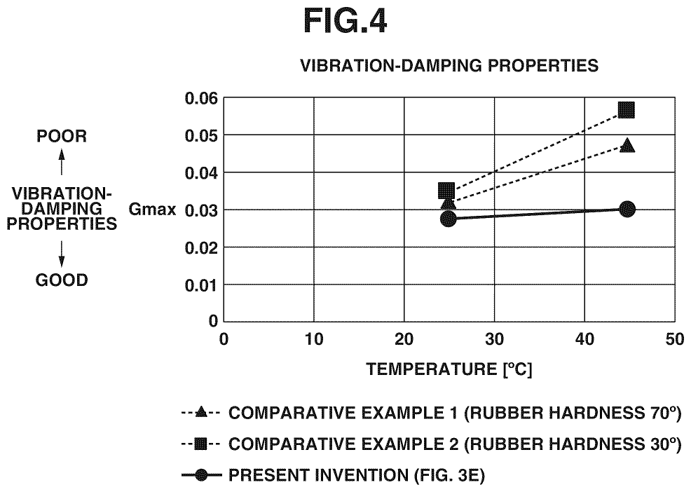

FIGS. 3A to 3I each illustrate a configuration example of each of the vibration member 104, the contact member 101, the vibration attenuation member 117, the restraining member 116, the fixed-side guiding member 113, and the rolling ball 114 in the vibrating actuator 100 according to the first exemplary embodiment. FIGS. 3A to 3I each illustrate an XYZ coordinate system corresponding to the XYZ coordinate system illustrated in FIGS. 1A to 1F.

As illustrated in FIGS. 3A to 3H, the fixed-side guiding member 113 is disposed with a wall portion 113c that protrudes in the Z-direction, and the fixed-side guiding member 113 has a concave sectional shape (U-shape). The provision of the wall portion 113c for the fixed-side guiding member 113 makes it possible to increase the rigidity and the mass, which leads to an improvement in vibration-damping properties. In the present exemplary embodiment, the fixing frame member 118 (resin with excellent vibration-damping properties) to which the contact member 101 is fixed serves a role similar to that of rubber, and the fixed-side guiding member 113 (metal) fixed to the fixing frame member 118 also serves as the restraining member 116. With this configuration, the degree of deformation or slippage on an interface increases as the difference between the bending rigidity of the fixing frame member 118 and the bending rigidity of the fixed-side guiding member 113 increases, which leads to an increase in a loss in the fixing frame member 118 and improvement in the damping performance. In other words, the degree of deformation or slippage on the interface increases as the difference in rigidity increases, so that a shear stress occurs. The vibration attenuation member 117 absorbs the shear stress as an internal friction and dissipates energy as heat. As a result, an energy loss in the vibration attenuation member 117 increases and the vibration-damping performance of the entire device is improved.

In FIGS. 3A and 3B, the vibration attenuation member 117 and the restraining member 116 are disposed on the side of the contact member 101 that is opposite to the side where the vibration member 104 is disposed. In addition, in FIGS. 3A and 3B, the restraining member 116 is disposed with a bending portion (also referred to as a “wall portion”) 116a that protrudes in the Z-direction, and the restraining member 116 has a concave sectional shape. The provision of the bending portion 116a for the restraining member 116 makes it possible to increase the rigidity (second moment of area) and the mass and improve the vibration-damping properties. This is because the degree of deformation or slippage on the interface increases as the difference between the bending rigidity of the vibration attenuation member 117 (rubber or the like) and the bending rigidity of the restraining member 116 (metal plate) increases, which leads to an increase in the loss in the vibration attenuation member 117 and an improvement of the damping performance. In the present exemplary embodiment, the direction of the bending portion 116a of the restraining member 116 is determined in consideration of the space for the vibrating actuator 100.

In FIG. 3C, the vibration attenuation member 117 and the restraining member 116 are disposed on the side of the contact member 101 that is opposite to the side where the vibration member 104 is disposed. In addition, in FIG. 3C, the restraining member 116 is disposed not only with the bending portion 116a protruding in the Z-direction, but also with a through-hole 116b extending in the X-direction. In the first exemplary embodiment, the hole 116b of the restraining member 116 is located at a position overlapping the convex portion (convex portion of the fixed-side rolling groove 113a illustrated in FIG. 1F) of the fixed-side guiding member 113 in the Z-direction. As illustrated in FIG. 3C, the restraining member 116 may be formed in a shape that prevents interference with the fixed-side guiding member 113, and the thickness of the restraining member 116 may be increased to thereby improve the vibration-damping properties.

In the configuration examples illustrated in FIGS. 1A to IF, the vibration attenuation member 117, the contact member 101, and the restraining member 116 are pressurized once to be integrally formed using high adhesion properties of the vibration attenuation member 117. After that, even when the pressure is relieved and the vibrating actuator 100 is formed in combination of other members, the adhesion of the vibration attenuation member 117 prevents the members from being peeled off.

However, depending on the material or hardness of the vibration attenuation member 117, the material or surface roughness of each of the contact member 101 and the restraining member 116, and the like, the adhesion between the vibration attenuation member 117 and the contact member 101 and the adhesion between the vibration attenuation member 117 and the restraining member 116 are not sufficient, which may cause peeling of these members. For example, in the case of using butyl rubber as a material for the vibration attenuation member 117, the vibration-damping properties of butyl rubber with hardness of 70° are higher than those with hardness of 30°, while the adhesion of butyl rubber with hardness of 70° is lower than that with hardness of 30°. Further, if a portion of the contact member 101 other than the portion that is in contact with the vibration member 104 is formed of resin as a material for the contact member 101, the adhesion is decreased.

FIGS. 3D and 3E each illustrate a configuration example in which a double-sided tape or an adhesive is used in addition to rubber for the vibration attenuation member 117 so as to improve the peeling strength of rubber that can be used as a material for the vibration attenuation member 117.

In FIG. 3D, the vibration attenuation member 117 and the restraining member 116 are disposed on the side of the contact member 101 that is opposite to the side where the vibration member 104 is disposed. In addition, in FIG. 3D, the vibration attenuation member 117 includes rubber 117a and a double-sided tape 117b that is disposed between the rubber 117a and the contact member 101 and between the rubber 117a and the restraining member 116. For example, a rubber-based double-sided adhesive tape that is formed of a special rubber-based adhesive as a component and has a thickness of 0.1 mm may be desirably used as the double-sided tape 117b. The use of the double-sided tape 117b makes it possible to improve the vibration-damping properties, in particular, at high temperature. In place of the double-sided tape 117b, an adhesive (cyanoacrylate-based adhesive or the like) may be used.

In FIG. 3E the vibration attenuation member 117 and the restraining member 116 are disposed on the side of the contact member 101 that is opposite to the side where the vibration member 104 is disposed. In addition, in FIG. 3E, the vibration attenuation member 117 includes the rubber 117a and an adhesive 117c that is used to bond the rubber 117a and the contact member 101 with the restraining member 116. In FIG. 3E, the adhesive 117c is preliminarily applied to a predetermined section on the restraining member 116, the rubber 117a and the contact member 101 are assembled in a pressurized state, and the adhesive 117c is hardened to integrally form the rubber 117a, the contact member 101, and the restraining member 116.

FIG. 3F illustrates a configuration example in which the vibration attenuation member 117 and the restraining member 116 are disposed on the side of the contact member 101 where the vibration member 104 is disposed. Specifically, in FIG. 3F, the vibration attenuation member 117 is disposed on the surface of the contact member 101 that is in contact with the vibration member 104. For example, if the width of the contact member 101 is sufficiently large, or if the height dimensions of the protruding portions 5 of the vibration member 104 are large, the contact area or thickness of the vibration attenuation member 117 can be sufficiently increased, so that out-of-plane vibration on the surface in contact with the vibration member 104 can be effectively damped.

FIG. 3G illustrates a configuration example in which the vibration attenuation member 117 and the restraining member 116 are disposed on the side of the contact member 101 where the vibration member 104 is disposed. Specifically, in FIG. 3G, a Y-Z section of the contact member 101 has a convex shape and the vibration attenuation member 117 and the restraining member 116 are disposed on thin portions of the contact member 101. In the configuration example illustrated in FIG. 3G, the vibration attenuation member 117 and the restraining member 116 can be formed with a greater thickness, which leads to an improvement in vibration-damping properties.

FIG. 3H illustrates a configuration example in which the vibration attenuation member 117 and the restraining member 116 are disposed on the side of the contact member 101 where the vibration member 104 is disposed. Specifically, in FIG. 3H, the Y-Z section of the contact member 101 has a substantially dumbbell shape, and the vibration attenuation member 117 and the restraining member 116 are disposed on thick portions of the contact member 101. In the configuration example illustrated in FIG. 3H, the vibration attenuation member 117 and the restraining member 116 are arranged at positions far from a neutral plane in out-of-plane vibration to be reduced in the contact member 101. This configuration makes it possible to effectively damp the vibration.

FIG. 3I illustrates a configuration example in which the vibration attenuation member 117 and the restraining member 116 are disposed on the side of the contact member 101 that is opposite to the side where the vibration member 104 is disposed. In addition, FIG. 3E illustrates a configuration example in which the contact member 101 also functions as the fixed-side guiding member 113. Specifically, in the configuration example illustrated in FIG. 3G, the rolling ball 114 rolls on the surface (lower surface) of the contact member 101 that is opposite to the surface (upper surface) that is in contact with the vibration member 104.

FIG. 4 is a graph illustrating experimental results of vibration-damping properties of the vibrating actuator 100 according to the first exemplary embodiment and vibrating actuators according to Comparative Examples. A method for evaluating the vibration-damping properties illustrated in FIG. 4 will be described below.

FIG. 4 illustrates experimental results of vibration-damping properties of the vibrating actuator 100 according to the first exemplary embodiment, a vibrating actuator according to Comparative Example 1, and a vibrating actuator according to Comparative Example 2. Initially, in each of the three vibrating actuators, the vibration member 104 including the piezoelectric element 103 was arranged at the center of the contact member 101. After that, the contact member 101, the vibration attenuation member 117, the restraining member 116, and the fixed-side guiding member 113 were mounted on the fixing frame member 118. A maximum value Gmax in the real part of the admittance of the piezoelectric element 103 was measured with an impedance measuring instrument in a frequency range of 1 kHz to 100 kHz. In this case, some peaks appeared in the measured frequency range and the value of Gmax in the vicinity of 65 kHz at a highest peak was extracted. FIG. 4 illustrates average values measured for each of the configurations of three actuators, namely, the vibrating actuator 100 according to the first exemplary embodiment, the vibrating actuator according to Comparative Example 1, and the vibrating actuator according to Comparative Example 2. In FIG. 4, a smaller value of Gmax indicates better vibration-damping properties. Based on a finite element method (FEM) analysis, it can be considered that the fifth-order mode of out-of-plane vibration of the contact member 101 is excited in the vicinity of 65 kHz.

FIG. 4 illustrates experimental results of vibration-damping properties of the vibrating actuator 100 illustrated FIG. 3E in the vibrating actuator 100 according to the first exemplary embodiment as characteristics of the present disclosure as indicated by a solid line. In this case, butyl rubber with hardness of 70° is used for the vibration attenuation member 117.

FIG. 4 also illustrates experimental results of vibration-damping properties of the vibrating actuator that uses butyl rubber that has hardness of 70° and has a greater thickness as the vibration attenuation member 117 without using the restraining member 116 of the vibrating actuator 100 according to the present disclosure as characteristics of Comparative Example 1 as indicated by a dashed line. The vibrating actuator according to Comparative Example 1 has a configuration in which rubber of the vibration attenuation member 117 is held between the contact member 101 and the fixed-side guiding member 113 and crushed.

FIG. 4 also illustrates experimental results of vibration-damping properties of the vibrating actuator having a configuration in which the hardness of butyl rubber used as the vibration attenuation member 117 is changed to 30° from that of the above-described vibrating actuator according to Comparative Example 1 as characteristics of Comparative Example 2, as indicated by a dashed line.

The experimental results of vibration-damping properties illustrated in FIG. 4 show that the vibration-damping properties and the vibration-damping effect in the configuration of the vibrating actuator 100 according to the present disclosure are higher than those in the vibrating actuator according to Comparative Example 1 and the vibrating actuator according to Comparative Example 2. In particular, in the vibrating actuator according to Comparative Example 1 and the vibrating actuator according to Comparative Example 2, the vibration-damping properties at 45° C., which is a temperature higher than 25° C., degrades, while in the vibrating actuator 100 according to the present disclosure, the vibration-damping properties at such high temperature are excellent.

The vibrating actuator 100 according to the first exemplary embodiment described above includes the vibration member 104 including the piezoelectric element 103 as an electromechanical energy conversion element, and the contact member 101 configured to be in contact with the vibration member 104. The vibrating actuator 100 according to the first exemplary embodiment is a vibrating actuator that causes the vibration member 104 to vibrate to move the vibration member 104 and the contact member 101 relative to each other in the first direction (e.g., the X-direction in the present exemplary embodiment). In addition, the vibrating actuator 100 according to the first exemplary embodiment includes the springs 110 each serving as a pressing member to press the vibration member 104 and the contact member 101 in the second direction (e.g., the Z-direction in the present exemplary embodiment) intersecting with the above-described first direction. The vibrating actuator 100 according to the first exemplary embodiment includes the vibration attenuation member 117 that is disposed in the second direction with respect to the contact member 101 and attenuates unnecessary vibrations occurring in the contact member 101. Further, the vibrating actuator 100 according to the first exemplary embodiment includes the restraining member 116 that is disposed on the side of the vibration attenuation member 117 that is opposite to the side where the contact member 101 is disposed, and the vibrating actuator 100 has higher rigidity than the vibration attenuation member 117. The vibrating actuator 100 according to the first exemplary embodiment is configured to prevent the vibration attenuation member 117 from receiving the force in the second direction induced by the springs 110 each serving as the pressing member being pressed. For example, the vibrating actuator 100 according to the first exemplary embodiment has a configuration in which a gap formed between the restraining member 116 and the fixed-side guiding member 113 in the second direction prevents the vibration attenuation member 117 from receiving the force in the second direction that is induced by the springs 110 being pressed.

Specifically, Japanese Patent Application Laid-Open No. 2023-108498 discusses a first configuration example in which the vibration damping member serving as the vibration attenuation member is provided on the contact member in a direction in which a pressurization portion presses a vibration member and the contact member and the vibration damping member receives a force generated by the pressurization portion. In the first configuration example discussed in Japanese Patent Application Laid-Open No. 2023-108498, a pressurizing force (pressing force) generated by the pressurization portion varies as the thickness of rubber or the like included in the vibration damping member serving as the vibration attenuation member varies during mass production. As a result, variations in the performance of the vibrating actuator are more likely to occur.

Japanese Patent Application Laid-Open No. 2023-108498 also discusses a second configuration example in which the vibration damping member serving as the vibration attenuation member is provided on a side surface of the contact member in a direction different from the direction in which the pressurization portion presses the vibration member and the contact member. In the second configuration example discussed in Japanese Patent Application Laid-Open No. 2023-108498, the vibration damping member serving as the vibration attenuation member is provided at a position on the side surface of the contact member with less strain where unnecessary vibrations can occur, so that sufficient vibration-damping properties cannot be obtained.

With this configuration according to the present disclosure, variations in the performance of the vibrating actuator can be reduced while sufficient vibration-damping properties can be ensured.

Next, a second exemplary embodiment will be described. In the second exemplary embodiment to be described below, descriptions of matters that are common to those in the first exemplary embodiment described above will be omitted, and only matters that are different from those in the first exemplary embodiment described above will be described.

The second exemplary embodiment illustrates configuration examples of an optical device and an electronic device including the vibrating actuator 100 according to the first exemplary embodiment described above.

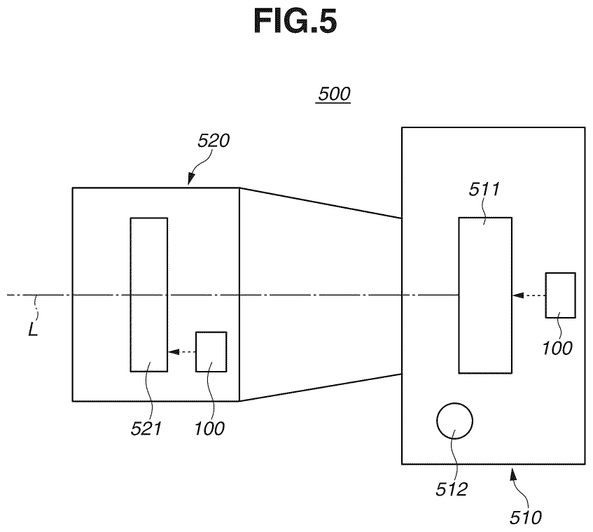

FIG. 5 is a top view illustrating an example of a schematic configuration of an imaging device 500 as an optical device according to the second exemplary embodiment. The imaging device 500 illustrated in FIG. 5 includes the vibrating actuator 100 according to the first exemplary embodiment described above.

The imaging device 500 includes the vibrating actuator 100 and a camera body 510 incorporating an image sensor 511 and a power button 512. The imaging device 500 includes the vibrating actuator 100 and a lens barrel 520 incorporating a lens group 521 serving as an optical element. The lens barrel 520 is replaceable as an interchangeable lens, and the lens barrel 520 suitable for an object to be captured by the imaging device 500 can be mounted on the camera body 510.

The vibrating actuator 100 incorporated in the lens barrel 520 mechanically drives the lens group 521 as the optical element. In this case, driving of an autofocus lens may be suitable as driving of the lens group 521 by the vibrating actuator 100. However, driving of the lens group 521 is not limited to this example. For example, driving of a zoom lens can also be applied.

The vibrating actuator 100 incorporated in the camera body 510 mechanically drives the image sensor 511.

In the example illustrated in FIG. 5, the vibrating actuator 100 can also be used to drive the lens group 521 or the image sensor 511 during camera shake correction.

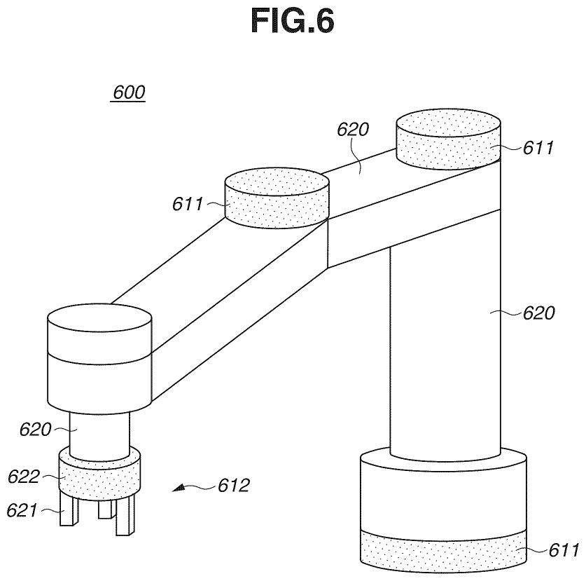

FIG. 6 is a perspective view illustrating an example of a schematic configuration of an industrial robot 600 serving as an electronic device according to the second exemplary embodiment. FIG. 6 illustrates a horizontal articulated robot serving as an example of the industrial robot 600.

The industrial robot 600 includes an arm joint portion 611, a hand portion 612, and arms 620. The arm joint portion 611 connects two arms 620 in such a manner that an angle at which the two arms 620 intersect with each other can be changed. As illustrated in FIG. 6, the hand portion 612 includes the arm 620, a grip portion 621 disposed at one end of the arm 620, and a hand joint portion 622 that connects the arm 620 and the grip portion 621 to each other.

The vibrating actuator 100 according to the first exemplary embodiment is incorporated in each of the arm joint portion 611 and the grip portion 621, and mechanically drives the arm joint portion 611 and the grip portion 621 as driven members which are to be driven, thereby performing an angle adjustment operation and a rotation operation on the arm 620 and the hand joint portion 622. The vibrating actuator 100 having TN characteristics (drooping characteristics representing a relationship between a load torque and a rotation speed) that provides high torque at low speed can be suitably used for a bending operation of the arm joint portion 611, which is an example of a driven member which is to be driven, and for a grip operation of the grip portion 621, which is an example of the member to be driven.

While the second exemplary embodiment illustrates the imaging device 500 (optical device) illustrated in FIG. 5 and the industrial robot 600 (electronic device) illustrated in FIG. 6, which are examples of devices including the vibrating actuator 100 according to the first exemplary embodiment described above, the second exemplary embodiment is not limited only to these devices. For example, an XY stage can be used as a device for driving the flat-plate-like contact member 101 in any direction within the plane.

According to the second exemplary embodiment, an optical device and an electronic device including the vibrating actuator 100 can be provided in which variations in the performance are reduced while sufficient vibration-damping properties are ensured.

The above-described exemplary embodiments of the present disclosure are merely specific examples for carrying out the present disclosure. The technical scope of the present disclosure should not be interpreted in a limited way. That is, the present disclosure can be carried out in various forms without departing from the technical idea or the main features thereof.

According to an aspect of the present disclosure, it is possible to reduce variations in the performance of a vibrating actuator while ensuring sufficient vibration-damping properties.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-107525, filed Jul. 3, 2024, which is hereby incorporated by reference herein in its entirety.

What is claimed is:

1. A vibrating actuator comprising:
a vibration member including an electromechanical energy conversion element;
a contact member configured to be in contact with the vibration member, the vibrating actuator causing the vibration member to vibrate to move the vibration member and the contact member relative to each other in a first direction;
a pressing member configured to press the vibration member and the contact member in a second direction intersecting with the first direction;
a vibration attenuation member configured to attenuate vibrations occurring in the contact member, the vibration attenuation member being disposed in the second direction with respect to the contact member; and
a restraining member disposed on a side of the vibration attenuation member opposite to a side where the contact member is disposed, the restraining member having higher rigidity than the vibration attenuation member.

2. The vibrating actuator according to claim 1, further comprising a guiding member configured to guide a relative movement of the vibration member and the contact member,
wherein a gap between the restraining member and the guiding member in the second direction prevents the vibration attenuation member from receiving a force in the second direction generated by pressing of the pressing member.

3. The vibrating actuator according to claim 2, wherein at least one of cotton, felt, gel, grease, a foam member, or a gas including air is present in the gap.

4. The vibrating actuator according to claim 2,
wherein the guiding member is joined to the contact member through a fixing member, and
wherein the vibrating actuator further comprises a rolling member configured to roll on a surface of the guiding member.

5. The vibrating actuator according to claim 4, wherein the fixing member is formed of at least one of a liquid crystal polymer (LCP) resin, an acrylonitrile butadiene styrene (ABS) resin, or a carbon fiber reinforced polymer polycarbonate (PC) resin.

6. The vibrating actuator according to claim 1, further comprising a rolling member configured to roll on a surface of the contact member opposite to a surface in contact with the vibration member.

7. The vibrating actuator according to claim 1, wherein the vibration attenuation member includes rubber and one of a double-sided tape or an adhesive.

8. The vibrating actuator according to claim 1, wherein the vibration attenuation member and the restraining member are disposed on a side of the contact member opposite to a side where the vibration member is disposed.

9. The vibrating actuator according to claim 1, wherein the vibration attenuation member and the restraining member are disposed on a side of the contact member where the vibration member is disposed.

10. The vibrating actuator according to claim 1, wherein the restraining member includes a bending portion and a hole.

11. The vibrating actuator according to claim 1, wherein the restraining member is configured to restrain deformation of the vibration attenuation member.

12. An optical device comprising:
a vibrating actuator;
an optical element; and
an image sensor,
wherein the vibrating actuator includes:
a vibration member including an electromechanical energy conversion element;
a contact member configured to be in contact with the vibration member, the vibrating actuator causing the vibration member to vibrate to move the vibration member and the contact member relative to each other in a first direction;
a pressing member configured to press the vibration member and the contact member in a second direction intersecting with the first direction;
a vibration attenuation member configured to attenuate vibrations occurring in the contact member, the vibration attenuation member being disposed in the second direction with respect to the contact member; and
a restraining member disposed on a side of the vibration attenuation member opposite to a side where the contact member is disposed, the restraining member having higher rigidity than rigidity of the vibration attenuation member,
wherein the vibrating actuator mechanically drives at least one of the optical element or the image sensor.

13. An electronic device comprising:
a vibrating actuator;
a driven member which is a member to be driven; and
an image sensor,
wherein the vibrating actuator includes:
a vibration member including an electromechanical energy conversion element;
a contact member configured to be in contact with the vibration member, the vibrating actuator causing the vibration member to vibrate to move the vibration member and the contact member relative to each other in a first direction;
a pressing member configured to press the vibration member and the contact member in a second direction intersecting with the first direction;
a vibration attenuation member configured to attenuate vibrations occurring in the contact member, the vibration attenuation member being disposed in the second direction with respect to the contact member; and
a restraining member disposed on a side of the vibration attenuation member opposite to a side where the contact member is disposed, the restraining member having higher rigidity than rigidity of the vibration attenuation member,
wherein the vibrating actuator mechanically drives the driven member.
